(19) United States
(12) Patent Application Publication
(10) Pub. No.: US 2010/0210502 A1
(43) Pub. Date: Aug. 19, 2010

(54) Polycyclic Compounds as Enzyme Stabilizers

(76) Inventors: Robin Ghosh, Dusseldorf (DE); Andreas Michèls, Dusseldorf (DE); Cornelius Bessler, Dusseldorf (DE); Daniela Lowis, Haan (DE)

Correspondence Address: Henkel Corporation, 10 Finderne Avenue, Bridgewater, NJ, 08807, US

(21) Appl. No.: 12/714,574

(22) Filed: Mar. 1, 2010

Related U.S. Application Data
(63) Continuation of application No. PCT/EP2008/061272, filed on Aug. 28, 2008.

(30) Foreign Application Priority Data
Sep. 4, 2007 (DE) 10 2007 041 754.5

(51) Int. Cl. C11D 3/386

(52) U.S. Cl. 510/392

(57) ABSTRACT

The present invention relates to laundry and cleaning agents containing polycyclic compounds that act as protease inhibitors and are therefore suitable enzyme stabilizers.

### CROSS REFERENCE TO RELATED APPLICATIONS

The present application is a continuation of International Patent Application No. PCT/EP2008/061272 filed 28 Aug. 2008, which claims priority to German Patent Application No. 10 2007 041 754.5 filed 4 Sep. 2007, both of which are incorporated herein by reference.

The present invention relates to washing and cleaning agents containing polycyclic compounds which act as protease inhibitors and are thus suitable enzyme stabilizers.

Use of enzymes in washing and cleaning agents has been established in the prior art for decades. They are used to extend the performance spectrum of the agents concerned according to their specific activities. These include in particular hydrolytic enzymes such as proteases, amylases, lipases and cellulases. The first three mentioned hydrolyze proteins, starch and fats and thus contribute directly to soil removal. Cellulases are used in particular because of their fabric effect. Another group of washing and cleaning agent enzymes is the oxidative enzymes, in particular oxidases, which are preferably used, optionally together with other components, to bleach soils or to produce the bleaching agents in situ. In addition to these enzymes, which are subject to continual optimization, further enzymes are continuously being provided for use in washing and cleaning agents, particularly in order to be able to deal optimally with specific soils, such as pectinases, β-glucanases, mannanases or further hemicellulases (glycosidases) for the hydrolysis of specific plant polymers in particular.

Enzymes that have been established the longest and are contained in virtually all modern high-performance washing and cleaning agents are proteases, and among these in particular serine proteases, which according to the invention also include the subtilases. They are used to break down protein-containing soils on the material to be cleaned. However, they also hydrolyze themselves (autoproteolysis) and all other proteins contained in the agents in question, i.e. in particular enzymes. This occurs particularly during the cleaning operation, i.e. in the aqueous washing solution, if comparatively favorable reaction conditions are present. However, this also occurs to a lesser extent during storage of the agents concerned, which is why a certain loss of protease activity and of the activities of the other enzymes is always associated with prolonged storage. This is particularly problematic in gel or liquid, and particularly aqueous, formulations, as both the reaction medium and the hydrolysis reagent are available in these with the water contained.

One objective in the development of washing and cleaning agent formulations consists in stabilizing the enzymes contained, particularly during storage. This is understood to mean protection from various unfavorable influences, such as for example from denaturation or decomposition by physical influences or oxidation. These developments place an emphasis on protecting the proteins and/or enzymes contained against proteolytic cleavage. This can take place by constructing physical barriers, for example by encapsulation of the enzymes in special enzyme granules or by packaging of the agents in two-chamber or multi-chamber systems. The other route often followed consists in adding chemical compounds which inhibit the proteases and thus act overall as stabilizers for proteases and the other proteins and enzymes contained. These must be reversible protease inhibitors, since the protease activity only has to be stopped temporarily, in particular during storage, but no longer during the cleaning process.

In the prior art, polyols, particularly glycerol and 1,2-propylene glycol, benzamidine hydrochloride, borax, boric acids, boronic acids or the salts or esters thereof are established as reversible protease inhibitors. Among these, primarily derivatives with aromatic groups, e.g. ortho-, meta- or para-substituted phenylboronic acids, should be mentioned, and in particular 4-formylphenylboronic acid, or the salts or esters of the above-mentioned compounds (see below). Particularly good protection is obtained if boric acid derivatives are used together with polyols as they can then form a complex that stabilizes the enzyme. Peptide aldehydes, i.e. oligopeptides with a reduced C terminus, particularly those consisting of 2 to 50 monomers, have also been described for this purpose. The peptide-type reversible protease inhibitors include ovomucoid and leupeptin, among others. Specific, reversible peptide inhibitors as well as fusion proteins made of proteases and specific peptide inhibitors are also used for this purpose.

Further established enzyme stabilizers are amino alcohols, such as mono-, di- and triethanolamine and propanolamine and mixtures thereof, aliphatic carboxylic acids up to C₁₂, such as e.g. succinic acid, other dicarboxylic acids or salts of said acids. End-capped fatty acid amide alkoxylates are also established for this purpose. Certain organic acids used as builders, as disclosed in WO 97/18287, are also able to stabilize an enzyme in addition to their function as builders.

Various classes of protease are established as washing and cleaning agent proteases, for example metalloproteases. However, owing to their favorable enzymatic properties such as stability or pH optimum, proteases of the subtilisin type (subtilases, subtilopeptidases, EC 3.4.21.62) occupy a prominent position among the washing and cleaning agent proteases. Owing to the catalytically active amino acids, they are classed as serine proteases. They act as non-specific endopeptidases, i.e. they hydrolyze any acid amide bonds present within peptides or proteins. Their pH optimum is generally in the distinctly alkaline range. A review of this family is provided e.g. by the article “Subtilases: Subtilisin-like Proteases” by R. Siezen, pages 75-95 in “Subtilisin enzymes” edited by R. Bott and C. Betzel, New York, 1996. Subtilases are formed naturally by microorganisms; among these, the subtilisins formed and secreted by Bacillus species should be mentioned in particular as the most important group within the subtilases.

Particular efforts are therefore being made to provide reversible inhibitors from precisely this class of enzymes. Polyols such as glycerol and 1,2-propylene glycol have proved disadvantageous in this respect owing to the high concentrations thereof that have to be used, because the other active substances in the agents concerned can therefore only be contained in correspondingly smaller proportions.

Among the serine protease inhibitors already effective in a comparatively low concentration, boric acid derivatives occupy a prominent position. Meta-substituted phenylboronic acids can be taken from WO 92/19707 A1 as examples of these. Para-substituted phenylboronic acids as protease inhibitors are disclosed by EP 478050 A1. The protease-inhibiting action of complexes of boric acids and boric acid derivatives with aromatic compounds is disclosed by EP 511456 A1. Protease-inhibiting derivatives of boronic acids and borinic acids, including aromatic compounds, are disclosed by WO 95/02046 A1. WO 95/29223 A1 discloses the same action of substituted naphthaleneboronic acids.

In addition, applications WO 96/21716 A1 and WO 96/41859 A1 should be mentioned. WO 96/21716 A1 cites the five applications just cited and discloses the fact that all of the protease inhibitors listed therein are also suitable for the specific purpose of stabilizing enzymes in washing and cleaning agents. A selection of particularly effective stabilizers among these is disclosed by WO 96/41859 A1.

In addition, there is prior art on the further increase of the action of these stabilizers. Thus, application WO 93/11215 A1 describes the combined use of 1,2-propanediol and boric acid or various boric acid derivatives for stabilizing liquid washing formulations and EP 451924 A2 discloses liquid washing formulations which are stabilized by the combined use of hydroxypolycarboxylic acids, calcium salt and specific boron compounds.

Independently of their stabilizing action, however, the boric acid derivatives exhibit a decisive disadvantage: many of them, such as e.g. borate, form undesirable by-products with some other washing or cleaning agent ingredients, and so these are no longer available for the desired cleaning purpose in the agents concerned, or even remain as soilage on the material being washed.

The problem therefore existed of identifying boron-free chemical compounds which act as protease inhibitors and thus are suitable as enzyme stabilizers in washing and cleaning agents.

Use in washing and cleaning agents that are, overall, in liquid, gel or paste form were of particular interest here, including in particular those containing water.

This problem is solved by the following agents—

washing or cleaning agents containing a protease and a compound of the general structural formula:

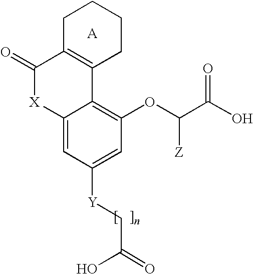

wherein
A is any 5- or 6-membered, mono- or polyunsaturated ring which may optionally also contain at least one hetero atom, particularly selected from O and N, A preferably being benzo, thiopheno, pyrido, pyrimidino, imidazo, oxazo, pyrrazo and pyrrolo residues;
X and Y are independently O, NR¹ or CR¹R², preferably O;
R¹, R² and Z are independently hydrogen, C₁₋₆ alkyl, particularly methyl, ethyl, propyl, butyl, pentyl or hexyl, C₁₋₆ alkenyl, particularly ethenyl, propenyl, butenyl, pentenyl or hexenyl, phenyl, benzyl or halogen, particularly fluorine, chlorine, bromine or iodine, preferably hydrogen; and
n=1 or 2.

In a preferred embodiment:
A is a residue chosen from benzo, thiopheno, pyrido, pyrimidino, imidazo, oxazo, pyrrazo and pyrrolo residues, particularly preferably a benzo, thiopheno or pyrido residue, most particularly a benzo residue;
X is O or NR¹, particularly preferably O;
Y is O or NH, particularly preferably O;
R¹ is benzyl;
Z is hydrogen; and
n is 1.

In a particularly preferred embodiment, the agent is a compound with the structural formula:

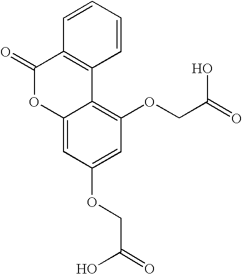

([1-(carboxymethoxy)-6-oxo-6H-benzochromen-3-yl]oxy}acetic acid (CAS: 133540-71-3)).

According to the invention, the term washing or cleaning agent is to be understood as all agents that are suitable for the washing or cleaning of, in particular, textiles and/or solid surfaces. Suitable ingredients for these are listed in detail below.

According to the invention, the term protease is to be understood as all enzymes that are capable of hydrolyzing acid amide links in proteins. The proteases are also listed in detail below.

Without wishing to be bound by this theory, it is assumed according to the invention that the compounds of relevance to the invention form a complex with the protease to be inhibited/stabilized according to the invention. It appears to be the case that the compound of relevance to the invention is inserted into the substrate-binding pocket of the protease and bonded there non-covalently. In this way the active centre of the protease is blocked by a compound which cannot be hydrolyzed by this enzyme, and it is not available to hydrolyze further proteins that are present. This is a reversible bond, i.e., an equilibrium between association and dissociation. The equilibrium coefficient of this reaction is referred to as the inhibition constant or Kᵢ.

The first advantage of the compounds of relevance to the invention over the prior art, apart from the lower volume thereof that is required compared with the polyols, consists in the fact that they have favorable inhibition constants with respect to the proteases that can be used in washing and cleaning agents. This is true of serine proteases, for example, but also of metalloproteases. The inhibitors thus bind reversibly, i.e., they enter into not too firm and not too loose temporary interactions with the enzyme. Advantageously, therefore, the majority of the protease of relevance to the invention is present during storage in the form of a protease inhibitor complex. The protease and any further proteins contained, in particular further enzymes, are thus protected from proteolysis by this enzyme (stabilized against proteolysis). On the other hand, at the moment when the agent according to the invention is diluted with water to produce an aqueous washing or cleaning solution during the cleaning process the bond equilibrium is shifted towards dissociation so that the complex breaks down and the majority of the protease of relevance to the invention becomes proteolytically active. The compounds of relevance to the invention are therefore functioning protease inhibitors and therefore enzyme stabilizers for washing and cleaning agents in accordance with the problem formulated.

The second advantage of the compounds of relevance to the invention over the prior art consists in the fact that they only contain as elements C, H, N and O, and optionally halides and/or sulfur and, in particular, they are free from boron. They therefore do not form the undesirable by-products with other washing or cleaning agent ingredients that are attributable to boron.

Moreover, particularly owing to the carboxyl groups contained in each aromatic ring, they have good solubility in water so they can be readily incorporated in appropriate agents, and precipitation during storage is avoided.

In principle, therefore, it is assumed that the aforementioned compounds act as reversible inhibitors because they are structurally adapted to the conditions of the binding pocket in a manner similar to the substrate of the proteases. Conversely, therefore, all proteases can in principle be inhibited by the compounds of relevance to the invention, so these are suitable as protease inhibitors according to the invention. This is particularly true of serine proteases, as has been demonstrated on the basis of the examples of the present application with the positive action of the compounds described there experimentally on the basis of serine proteases, and specifically subtilases, or more specifically, subtilisins based on a variant of the subtilisin from Bacillus lentus DSM 5483.

The present invention also provides:
use of a compound described above as a reversible inhibitor and/or stabilizer of a protease within the framework of a washing or cleaning agent formulation;
washing or cleaning methods in which a protease becomes effective, which is inhibited and/or stabilized with a compound described above;
the use of a washing or cleaning agent according to the invention for the washing and/or cleaning of textiles and/or hard surfaces; and
use of a protease and a compound described above for the production of a washing or cleaning agent.

According to the invention, those washing or cleaning agents are preferred in which the stabilizing compound has an inhibition constant (Kᵢ) of 0.01 to 10 mM, preferably 0.1 to 5 and particularly preferably 0.5 to 2 with respect to the protease contained.

The inhibition constant Kᵢ can be determined in the following way:

For the characterization of a reversible inhibitor of enzymatic activity, the inhibition constant Kᵢ is a characteristic and decisive value. Kᵢ describes the equilibrium between enzyme, inhibitor and enzyme-inhibitor complex for a reversible bond. The enzyme-inhibitor complex here is not catalytically active and inhibits the reaction by reducing the concentration of free enzyme that is still available for binding substrate. The Kᵢ is accordingly defined as:

Kᵢ=[I]×[E]/[EI]

[I], [E], and [EI] here signify the respective molar equilibrium concentrations of inhibitor [I], enzyme [E] and enzyme-inhibitor complex [EI]. According to this definition, a substance with a low K, under the respective test conditions is a good inhibitor.

The determination of Kᵢ takes place on the basis of the activity test of the protease in the presence of the corresponding inhibitor. By means of the established Michaelis-Menten kinetics, the enzymatic parameters Kₘ and k_{cat} are determined in the presence of different concentrations of the inhibitor. By determining the initial rate of hydrolysis (vₒ) at different substrate concentrations [S] and fitting the experimental data into Equation 1, Kᵢ is obtained.

vₒ=k_{cat}×[S]×Eₒ/(Kₘ×(1+[I]/Kᵢ)+S) Equation 1

[I] again is inhibitor concentration here.

Alternatively, Kᵢ can be determined using the Cheng-Prusoff equation (Equation 2) by means of the IC₅₀ value. The determination of the IC₅₀ value takes place by determining the proteolytic activity on a substrate in the presence of different concentrations of the inhibitor and fitting the experimental data into a sigmoidal dose-response equation with variable slope (pseudo-Hill slopes). This refers to the value of half of the concentration of inhibitor that would be needed to achieve complete inhibition.

Kᵢ is thus obtained from the following equation 2:

Kᵢ=IC₅₀/(1+[S]/K_{d}) Equation 2

[S] here signifies substrate concentration in the test and K_{d} the equilibrium dissociation constant for the substrate, which can be taken as identical to Kₘ for the substrate where IC₅₀ is used.

Kᵢ values that can be determined in this way characterize the compound under investigation with respect to the protease used in the test. In Example 2, this was carried out for the Bacillus lentus alkaline protease F49 (according to WO 95/23221 A1). Since this is a typical subtilisin protease, the values obtained with this enzyme are also typical of other serine proteases, and particularly other subtilisin proteases. If there is any doubt, the precise value of a protease of interest must be determined on the basis of the specific protease in each case.

In washing or cleaning agents according to the invention, which in a preferred embodiment are present in predominantly solid form and in a second embodiment in predominantly liquid, paste or gel form, the protease is particularly contained in an amount of 2 μg to 20 mg per g of the agent, preferably 5 μg to 17.5 mg per g of the agent, particularly preferably 20 μg to 15 mg per g of the agent and most preferably 50 μg to 10 μg of the agent.

The stabilizer is contained in agents according to the invention in an amount of up to 50 mg per g of the agent, preferably up to 10 mg, particularly preferably up to 7 mg and most preferably up to 5 mg per g of the agent. Furthermore, it is preferred that the stabilizer is contained in an amount of 0.01 to 100×Kᵢ (based on the protease contained), preferably 0.1 to 10×Kᵢ and particularly preferably 1 to 5×Kᵢ.

The molar ratio of stabilizer to protease is preferably in the range of 1:1 to 1000:1, in particular from 1:1 to 500:1, particularly preferably from 1:1 to 100:1 and most preferably from 1:1 to 20:1.

In addition to the stabilizer according to the general formula given above, an agent according to the invention can contain at least one further stabilizer, in particular a polyol such as glycerol or 1,2-ethylene glycol, and/or an antioxidant.

The protease stabilized or reversibly inhibited according to the invention is preferably a serine protease, in particular a subtilase, particularly preferably a subtilisin. Subtilisin here can be a wild-type enzyme or a subtilisin variant, the wild-type enzyme or starting enzyme of the variant preferably being selected from one of the following:
the alkaline protease from Bacillus amyloliquefaciens (BPN′),
the alkaline protease from Bacillus licheniformis (subtilisin Carlsberg),
the alkaline protease PB92,
subtilisin 147 and/or 309 (savinase),
the alkaline protease from Bacillus lentus, preferably from Bacillus lentus (DSM 5483),
the alkaline protease from Bacillus alcalophilus (DSM 11233),
the alkaline protease from Bacillus gibsonii (DSM 14391) or an alkaline protease at least 70% identical therewith,
the alkaline protease from Bacillus sp. (DSM 14390) or an alkaline protease at least 98.5% identical therewith,
the alkaline protease from Bacillus sp. (DSM 14392) or an alkaline protease at least 98.1% identical therewith,
the alkaline protease from Bacillus gibsonii (DSM 14393) or an alkaline protease at least 70% identical therewith,
the alkaline protease described in SEQ ID NO. 4 of application WO 2005/063974 A1 or an alkaline protease at least 40% identical therewith,
the alkaline protease described in SEQ ID NO. 4 of application WO 2005/103244 A1 or an alkaline protease at least 80% identical therewith,
the alkaline protease described in SEQ ID NO. 7 of application WO 2005/103244 A1 or an alkaline protease at least 80% identical therewith, and
the protease described in SEQ ID NO. 2 of application DE 102005028295.4 or a protease at least 66% identical therewith.

In a preferred embodiment, the protease is a variant with a point mutation in the region of positions 95 to 103 (numbering as in subtilisin 309), preferably with an insertion of an individual amino acid between positions 99 and 100, particularly preferably starting from subtilisin 147 and/or 309 (subtilisin 309) or a variant thereof. In particular, the protease is a variant with a point mutation in position 217 (numbering as in the wild-type protease from Bacillus amyloliquefaciens; BPN′), preferably with a substitution of an individual amino acid in this position, particularly preferably with the amino acid substitution X217L, most preferably starting from the wild-type protease from Bacillus amyloliquefaciens (BPN′) or a variant thereof. In a preferred embodiment, the protease is a variant with an amino acid change compared with a starting protease that can be homologized with the alkaline protease from Bacillus lentus in one or more of the following positions: 3, 4, 36, 42, 43, 47, 56, 61, 69, 87, 96, 99, 101, 102, 104, 114, 118, 120, 130, 139, 141, 142, 154, 157, 188, 193, 199, 205, 211, 224, 229, 236, 237, 242, 243, 250, 253, 255 and 268, in the numbering of the alkaline protease from Bacillus lentus, preferably with an amino acid change compared with the starting molecule in one or more of the following positions: 3, 4, 43, 61, 188, 193, 199, 211, 224, 250 and 253, particularly preferably with one or more of the amino acid exchanges X3T, X41, X43V, X61A, X188P, X193M, X1991, X211D, X211E, X211G, X211N or X211Q, X224V, X250G and X253N, most preferably starting from the alkaline protease from Bacillus lentus DSM 5483 or a variant thereof.

Agents according to the invention may contain one or more further enzymes in addition to the protease, particularly from the following group: one or more further proteases, amylases, hemicellulases, cellulases, lipases and oxidoreductases. The amylase is preferably an α-amylase. The hemicellulase is preferably a β-glucanase, a pectinase, a pullulanase and/or a mannanase. The cellulase is preferably a cellulase mixture or a single-component cellulase, preferably or predominantly an endoglucanase and/or a cellobiohydrolase. The oxidoreductase is preferably an oxidase, in particular a choline-oxidase, or a perhydrolase.

Agents according to the invention preferably contain at least one complexing agent and/or builder substances, the builder being in particular a zeolite builder, and/or a non-ionic surfactant, the non-ionic surfactant preferably being a hydroxy mixed ether, and/or optical brightener, the optical brightener being biphenyl compounds, in particular distyryl biphenyl derivatives, and/or stilbene triazine derivatives.

### EXAMPLES

### Example 1

### Investigation of Residual Protease Activity in the Presence of an Inhibitor

To prove that the compounds according to the invention have a protease activity-inhibiting action, the residual proteolytic activity of the Bacillus lentus alkaline protease F49 (according to WO 95/23221 A1) is determined in the presence of these compounds.

In parallel reaction batches, 0.1% (w/v) BrijTM35, the substrate succinyl alanine-alanine-proline-phenylalanine-para-nitroanilide (AAPFpNA; Bachem L-1400) and 5×10⁻⁹ or 1×10⁴ M of the protease are presented in 100 mM tris buffer, pH 6.8. The compounds to be tested are added in a final concentration of 10 mM. They are each dissolved in anhydrous DMSO, effects of DMSO on the enzymatic activity being corrected by means of the corresponding reference with the same amount of DMSO but without the compound concerned. The incubation took place for 5 min at pH 8.6 and 25° C. 1 U here corresponds to 1 μmol of cleaved substrate per minute.

Using [1-(carboxymethoxy)-6-oxo-6H-benzochromen-3-yl]oxy}acetic acid (CAS: 133540-71-3), it was possible in this way to achieve inhibition of the residual proteolytic activity to a residual activity of less than 50%.

### Example 2

### Investigation of Storage Stability of Protease-Containing Washing and Cleaning Agents in the Presence of Protease Inhibitors

As the basic formulation, a liquid washing with the following composition is prepared (all data are in percent by weight): 0.3-0.5% xanthan gum, 0.2-0.4% antifoam, 6-7% glycerol, 0.3-0.5% ethanol, 4-7% FAEOS, 24-28% non-ionic surfactants, 1% boric acid, 1-2% sodium citrate (dihydrate), 2-4% soda, 14-16% coconut fatty acids, 0.5% HEDP, 0-0.4% PVP, 0-0.05% optical brightener, 0-0.001% colorant, remainder: demineralized water.

The inhibiting compounds to be tested are added to this formulation together with 1,275,000 HPU/I B. lentus alkaline protease F 49. The protease activity expressed in HPU (Henkel Protease Units) is determined by the method of Raay, Saran and Verbeek according to the publication “Zur Bestimmung der proteolytischen Aktivität in Enzymkonzentraten und enzymhaltigen Wasch-, Spül- und Reinigungsmitteln” in Tenside, Vol. 7 (1970), pp. 125-132.

Storage took place for various lengths of time in airtight sealed vessels at 30° C.

For evaluation purposes, the initial values for the proteolytic activity of the agent concerned are compared with the values determined after storage. The higher the activity remaining after storage, the better the protease contained is inactivated during storage and the more suitable the compound concerned is as a stabilizer according to the invention.

We claim:

1. Washing or cleaning agent comprising a protease and an enzyme stabilizer having the general structural formula: 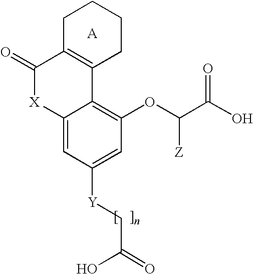
wherein
A is any 5- or 6-membered, mono- or polyunsaturated ring optionally containing at least one hetero atom,
X and Y are independently O, NR' or CR¹R²,
R¹, R² and Z are independently hydrogen, C₁₋₆ alkyl, C₁₋₆ alkenyl, phenyl, benzyl or halogen, and
n=1 or 2.

2. Washing or cleaning agent according to claim 1, wherein A is benzo, thiopheno, pyrido, pyrimidino, imidazo, oxazo, pyrrazo or pyrrolo residues; X is O or NR¹; Y is O or NH; and R¹ is benzyl.

3. Washing or cleaning agent according to claim 1, wherein the enzyme stabilizer is a compound having the general formula:

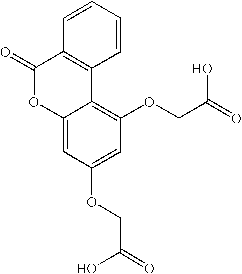

4. Washing or cleaning agent according to claim 1, wherein the agent is in substantially solid, liquid, paste or gel form.

5. Washing or cleaning agent according to claim 1, wherein the protease is a serine protease.

6. Washing or cleaning agent according to claim 5, wherein the serine protease is a subtilase.

7. Washing or cleaning agent according to claim 6, wherein the subtilase is a subtilisin.

8. Washing or cleaning agent according to claim 1, further comprising at least one stabilizer.

9. Washing or cleaning agent according to claim 8, wherein the at least one further stabilizer is a polyol and/or an antioxidant.

10. Washing or cleaning agent according to claim 1, further comprising one or more enzymes chosen from proteases, amylases, hemicellulases, cellulases, lipases and oxidoreductases.

11. Washing or cleaning method in which a protease becomes effective which is inhibited and/or stabilized with a compound of the general structural formula: 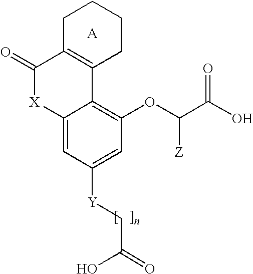
wherein
A is any 5- or 6-membered, mono- or polyunsaturated ring optionally containing at least one hetero atom,
X and Y are independently O, NR¹ or CR¹R²,
R¹, R² and Z are independently hydrogen, C₁₋₆ alkyl, C₁₋₆ alkenyl, phenyl, benzyl or halogen, and
n=1 or 2.

12. Washing or cleaning agent according to claim 1, wherein the stabilizing compound has an inhibition constant (Kᵢ) of 0.01 to 10 mM, based on the amount of protease.

13. Washing or cleaning agent according to claim 1, wherein the protease is present in an amount of 2 μg to 20 mg per g of the agent.

14. Washing or cleaning agent according to claim 1, wherein the stabilizer is present in an amount of up to 50 mg per g of the agent.

15. Washing or cleaning agent according to claim 1, wherein the molar ratio of stabilizer to protease is in the range of 1:1 to 1000:1.

16. The washing or cleaning agent according to claim 1, further comprising at least one complexing agent and/or builder substances.

17. The washing or cleaning agent according to claim 1, further comprising at least one non-ionic surfactant.

18. The washing or cleaning agent according to claim 1, further comprising at least one optical brightener.
